(19) United States
(12) Patent Application Publication
(10) Pub. No.: US 2007/0112861 A1
(43) Pub. Date: May 17, 2007

(54) Selection of a subset of assets based upon unrelated user preferences

(76) Inventors: Joseph Buczek, San Jose, CA (US); Allan Hoeltje, Oakland, CA (US)

Correspondence Address: Law Offices of Terry McHugh, 101 First Street - PMB 560, Los Altos, CA, 94022, US

(21) Appl. No.: 11/601,001

(22) Filed: Nov. 17, 2006

Related U.S. Application Data
(60) Provisional application No. 60/737,721, filed on Nov. 17, 2005.

(51) Int. Cl. G06F 17/00

(52) U.S. Cl. 707/104.1

(57) ABSTRACT

A system and method for the automated selection of digital music or other personal digitized assets within a library includes matching the relevance of the assets against inputs from one or more information sources that are designated by the user. As a result, a subset of the personal digitized assets is identified. The determination of relevance may be a comparison of metadata of each asset with information received via the Internet, such as by RSS (Really Simple Syndication) streams. In addition to use of the invention with music, the relevance selection of the invention may be applied to libraries of digital photographs, videos, electronic books, and audio files.

### CROSS REFERENCE TO RELATED APPLICATION

This application claims priority from co-pending provisional application Ser. No. 60/737,721, filed Nov. 17, 2005.

### TECHNICAL FIELD

The invention pertains to systems for, and methods of, selecting items from a person's digital music collection (DMC), but aspects can be extended to other types of collections.

### BACKGROUND ART

As one of the consequences of rapid advances in the field of personal computing and digital storage products, individuals are accumulating large libraries of personal digitized assets. As used herein, a “personal digitized asset” is defined as a unit of digital information that may be accessed with the appropriate “player” software. Examples of personal digitized assets include songs, photographs, videos, electronic books, and audio books or other spoken-word audio files. The videos may be short clips, recorded television episodes, or full-length movies.

The library of personal digitized assets may form a DMC (Digital Music Collection). The DMC may be contained within a single storage device, such as the hard drive of a home computer, or may be distributed among different storage devices that are accessible by a user. For example, the DMC of a particular user may be distributed among different storage devices of a single computer or over multiple compact discs (CDs) owned by the user.

A user having an extensive library of personal digitized assets may encounter the arduous task of manually selecting a subset of the assets for easy access or immediate play. Portable devices specifically designed for one or more types of personal digitized assets are commercially available. Such a “portable entertainment unit” may include storage for a large number of songs, but not the entire music library of a user. Rotating the songs stored on the entertainment unit (music player) maintains the “freshness” of the unit, but requires an investment in time. For the assets contained on a portable entertainment unit, determining the order of “play” is also an issue.

Software for providing automatic selection of music is known. In a simple form, music is randomly ordered in a “shuffle.” More complex selection assistance for music and for other types of personal digitized assets decreases the time requirements upon a user. The known techniques operate well for their intended purpose, but further developments are sought.

### SUMMARY OF THE INVENTION

The present invention provides a method and system that allows automatic selection of a subset of personal digitized assets on the basis of detecting relevance between particular assets and information received by at least one information source designated by a user of a portable device enabled to access the assets. In one embodiment, the selection of the subset is for the purpose of determining play, while in other embodiments, the selection may be for the purpose of loading the selected subset from the storage of the library to the storage of the portable device. In perhaps its preferred embodiment, the portable device is a music player.

The identification of relevance may be a matching of data from the designated information source with asset filenames. For music, an asset filename is often the title of the song. A more thorough embodiment looks to metadata of the personal digitized assets. As is known in the art, metadata is content-related data of a personal digitized asset. For music, metadata may include copyright dates, download dates, artist names, lyrics, composers, studios, file size, play parameters, ratings, genre, and even melodies. A data-to-metadata matching algorithm may be configured to detect connections between the assets and the inputs from the one or more designated information sources.

In one embodiment, the inputs from the designated information source or sources are RSS (Really Simple Syndication) streams or “feeds,” which provide summary information factually or socially related to popular media. Typically, an RSS feed is via the global communications network referred to as the Internet. Some information providers offer RSS feeds without charge, while others require a fee for the service. In many cases, Web pages may be served to client browser software without regard for the manner in which the provided information is used, assuming that copyrights are respected.

The data from the information source or sources may be news that is related to current political and social events. An apparent relevance match would be one in which an artist is mentioned in an RSS feed, so that a selected subset will include all songs by that artist. Perhaps a somewhat less apparent relevance match would be one in which a current event bears a relationship to the subject matter of a song. As one example, an RSS feed may include an announcement of the beginning of the baseball World Series, causing all baseball-related songs to be selected. The configuration and complexity of the algorithm will determine the extent to which relevance matching is recognized, such as the selection of all sports-related assets in response to an input related to the World Series.

As alternatives, the information source may not be connected via the Internet, since other possibilities are available. The connectivity with the information source may be wireless. In the preferred embodiment, the inputs from the information source are not directed to the type of personal digitized assets being selected. That is, the information source is not specifically designed for selecting the subset. However, there may be embodiments in which the information source is one that promotes certain assets, such as where an information provider promotes selections of musicians, actors, and writers who create assets likely to be within a user's Digital Music Collection. The information provider may present the information for use in the selection process, causing certain personal digitized assets that may be in a user's collection to be selected.

### BRIEF DESCRIPTION OF THE DRAWINGS

FIG. 1 is a schematic view representing a typical personal computing system in a broadband network environment in which the present invention may be implemented.

FIG. 2 is a process flow of steps in accordance with the invention.

### DETAILED DESCRIPTION

The present invention provides ways in which an owner of a collection of personal digitized assets can “consume” those assets in varying ways based on regularly changing information, such as a daily opinion column, and/or based on current events taking place in the real world, such as news, weather and other categories of activities.

Personal digitized assets become increasingly more difficult to utilize as the collection of assets increases in size. Moreover, the owner of such a collection has a tendency to use the assets less effectively, since contents of the collection become less familiar. For example, pictures which are not viewed regularly may be forgotten and popular music which is played frequently when first purchased becomes forgotten as time passes.

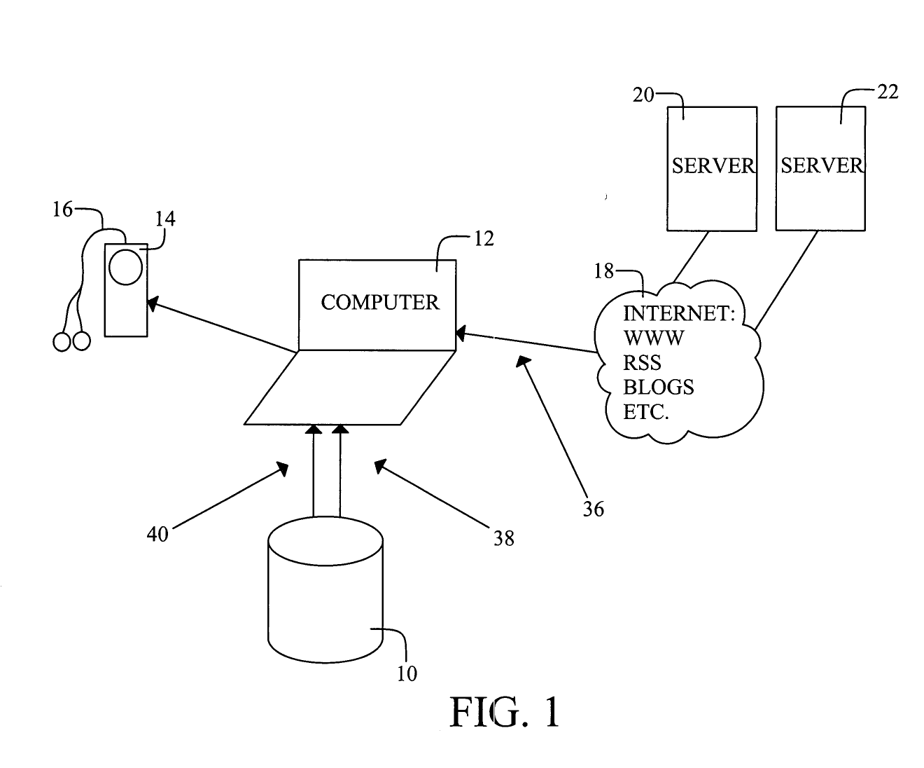

The focus of the present invention is the use of asset collections for entertainment, particularly music assets. Digital music players may be loaded with a subset of the assets from the collection of an owner. With reference to FIG. 1, a library 10 of assets is shown as being connected to a computer 12. The library may be a hard drive, multiple hard drives, compact discs or other storage means available to the conventional computer. Also shown in FIG. 1 is a music player 14 having earphones 16 for use by the owner. In addition to the library, the computer includes programming for implementing the selection of a subset of assets from the library 10.

In the embodiment represented by FIG. 1, information that is used in the asset-selection algorithm is acquired via the Internet 18. The information may be received via RSS feeds, Web logs (blogs), and other sources of frequently updated information. In FIG. 1, a pair of servers 20 and 22 are shown as being representative of the information sources. While the Internet is perhaps the most efficient manner of acquiring information from sources designated by a user at a computer, other possibilities are contemplated.

The algorithm executed within the computer 12 determines relevance of the personal digitized assets with information acquired from the information sources designated by the user. For example, if a story concerning a famous person, place or item appears in a news article received at the computer 12, assets that make reference to the subject can be selected for playback at the computer or for loading onto the music player 14.

Commercially available digital music players 14 have cycled through multiple design centers, starting with solid-state storage, moving to a large capacity disc storage, and most recently, back to solid-state storage. The solid-state storage devices have power consumption advantages over disc storage, as well as advantages in storage capacity, resistance to damage, and perhaps cost.

Inexpensive portable entertainment units, such as the music player 14 of FIG. 1, typically will contain less than all of the assets that can be stored within the library 10 available to the computer 12. Thus, users are faced with having to select and install assets into their players with regularity in order to facilitate full enjoyment of the breadth of the collection.

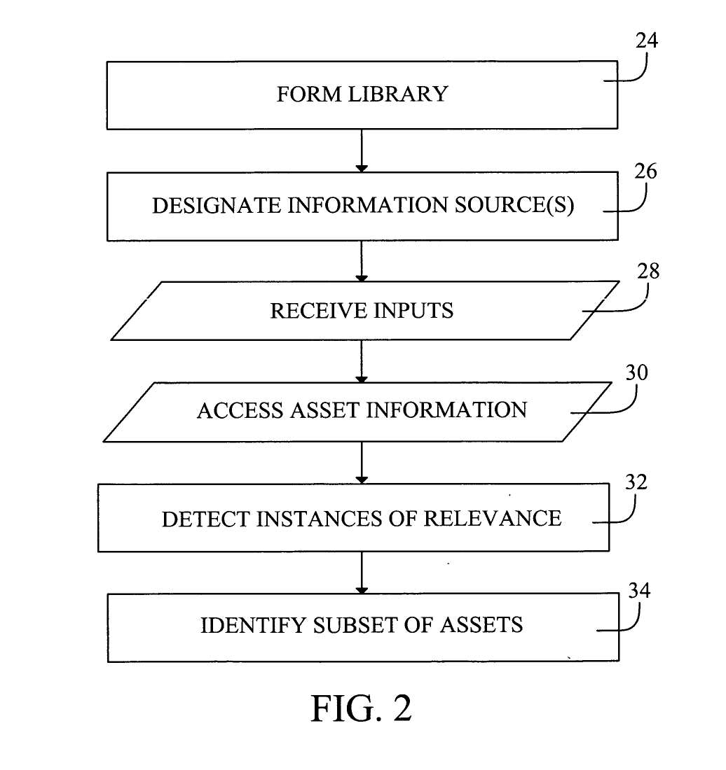

FIG. 2 represents one implementation of the invention for overcoming the current shortcomings. In step 24, the library of assets is formed. For purposes of explanation, a music library will be discussed. However, other personal digitized assets may be manipulated in the manner described herein.

At step 26, a user designates at least one information source, as previously noted. Arrow 36 in FIG. 1 and step 28 in FIG. 2 represent the incoming information that is used in the asset selection process.

At step 30, the information regarding individual personal digitized assets is accessed (arrow 38 in FIG. 1). This information may be merely the title of files. A more powerful embodiment is one in which metadata is accessed. The metadata may include copyright data, download dates, artist names, lyrics, composers, studies, file sizes, play parameters, ratings, genre, and even melodies.

At step 32, the information received from the designated information source or sources is compared to the asset information accessed at step 30. The processing identifies particular personal digitized assets that are relevant to the data received from the information source or sources. That is, data-to-metadata matching may be implemented. Step 34 is one in which the subset of assets having relevance are identified (represented by arrow 40 in FIG. 1). For embodiments of the invention in which there are no transfers of assets as a result of the processing, step 34 may be distinguishable from step 32 by defining a playlist as the identification of the subset. On the other hand, in the embodiment of FIG. 1, step 34 may include loading the subset of assets onto the music device 14.

An advantage of the invention is that independent considerations of a user may be “merged.” In the normal use of a personal computer or similar device that has the storage for maintaining an extensive library of personal digitized assets, such as digitized songs, the user will often establish preferences and identify areas of interest. The established preferences and interests may be completely unrelated to the preferences and interests involved in accumulating the library of assets. For example, the user may request RSS feeds related to a favorite sport, type of movie, or social or political area. Then, when the user connects a digital music player to the computer in order to load a subset of the stored assets, a matching algorithm that is part of the executing software package automatically detects associations between the information received via the RSS feeds and assets of relevance. On opening day of the baseball season, baseball-related songs may be preferentially selected as being part of the subset. On the same day, information may be received concerning a marriage or event in the life of an artist, with this information then being used to form another part of the subset. At times, the cause for selecting a particular personal digitized asset may not be obvious to the user. As a possible convenience feature of the invention, the reason for selection of each asset may be available to the user.

As previously noted, the invention is described primarily with regard to music assets, but is equally applicable to other types of personal digitized assets.

What is claimed is:

1. A computer-implemented method of automatically selecting from a library of personal digitized assets comprising:
receiving inputs from at least one information source designated by a user of a portable device enabled to access said personal digitized assets;
executing processing configured to identify instances of said personal digitized assets having a relevance to said inputs from said at least one information source; and
selecting a subset of said personal digitized assets on a basis of said relevance and as a basis for use of said portable device in accessing said personal digitized assets.

2. The method of claim 1 further comprising:
storing said library of said personal digitized assets separately from said portable device; and
loading said subset to said portable device upon selecting said subset of personal digitized assets.

3. The method of claim 2 wherein said storing of said library provides a storage that is accessible by a computer having programming to execute said processing for identifying said instances having relevance, said computer having an output selectively linked to said portable device for loading said subset.

4. The method of claim 1 wherein selecting said subset includes generating a list of said personal digitized assets having said relevance, such that said personal digitized assets of said list are identified for preferential access by said portable device.

5. The method of claim 1 wherein receiving said inputs includes receiving at least one RSS (Really Simple Syndication) feed designated by said user.

6. The method of claim 5 wherein said receiving includes designating at least one RSS feed that is from a source of information of current events that is not specific to the type of said personal digitized assets within said library.

7. The method of claim 6 wherein said personal digitized assets are songs and said designating is a step of identifying a news source.

8. The method of claim 1 wherein said selecting is a selection from a library of at least one of photographs, recorded videos and recorded television shows.

9. The method of claim 1 wherein said selecting is a selection from a library of printed matter.

10. The method of claim 1 wherein said receiving is from an information source located remotely from said portable device, said portable device being an entertainment unit having storage for at least said subset of personal digitized assets.

11. The method of claim 10 wherein said receiving is via the global communications network referred to as the Internet.

12. The method of claim 1 further comprising a step of automatically loading said subset onto said portable device as a direct response to said selecting said subset.

13. The method of claim 1 wherein said processing is enabled to compare metadata associated with individual said personal digitized assets to information received from said information sources.

14. A system for enabling computer-implemented selections of personal digitized assets comprising:
storage of a library of said personal digitized assets;
an input connected to receive information from at least one remote source of information selected by a user;
programming configured to detect relevance between said information and particular said personal digitized assets within said library; and
a portable entertainment unit for presenting said personal digitized assets, said portable entertainment unit being responsive to said results of said programming in detecting said relevance.

15. The system of claim 14 further comprising a computer to which said portable entertainment unit is selectively connected, said storage and said programming being within said computer.

16. The system of claim 15 wherein said programming is configured to automatically load said particular personal digitized assets for which relevance is detected, said loading being to said portable entertainment unit.

17. The system of claim 15 wherein said computer is configured and connected to receive said information as RSS feeds.

18. The system of claim 14 wherein said personal digitized assets are digitized songs, said programming being enabled to compare metadata of said digitized songs to said received information.

19. The system of claim 18 wherein said information is selected on a basis unrelated to providing information directly related to music.

20. The system of claim 18 wherein said information is selected on a basis of being related to providing information directly related to music.
